(19) United States
(12) Patent Application Publication
(10) Pub. No.: US 2024/0297978 A1
(43) Pub. Date: Sep. 5, 2024

(54) CASCADING NAVIGATIONAL PARAMETER FROM PARENT TO CHILD VOLUMETRIC VIDEO

(71) Applicant: International Business Machines Corporation, Armonk, NY (US)

(72) Inventors: Sarbajit K. Rakshit, Kolkata (IN); Vinod A. Valecha, Pune (IN)

(21) Appl. No.: 18/116,874

(22) Filed: Mar. 3, 2023

(51) Int. Cl. H04N 13/388; H04N 21/482

(52) U.S. Cl. CPC H04N 13/388; H04N 21/482

(57) ABSTRACT

A volumetric video analysis method, system, and computer program product that includes analyzing a plurality of volumetric videos to create a hierarchical relationship between the plurality of volumetric videos and navigating between a first volumetric video and a second volumetric video of the plurality of volumetric videos based on the hierarchical relationship.

### BACKGROUND

The present invention relates generally to a volumetric video analysis method, and more particularly, but not by way of limitation, to a system, method, and computer program product to perform a volumetric video analysis, thereby to perform seamless navigation in hierarchical volumetric videos.

Volumetric video technology leverages cameras and advanced data processing to render three-dimensional (3D) images from a virtual space, which allows for video point-of-views to be generated from any angle within that space to create a more immersive experience for viewers. Using volumetric videos, a user can view the media from various directions, use virtual reality systems, 3D display systems, and/or any two-dimensional (2D) display system.

Conventionally, volumetric video analysis operates on a single volumetric video. Or, in the conventional techniques, when navigating from a parent volumetric video to a child volumetric video, the child volumetric video does not receive a navigation pattern or context of navigation in the parent volumetric video. Thus, in the conventional techniques, seamless navigation from a parent volumetric video to a child volumetric video is not possible.

Thereby, there is a technical problem in the art for a cross volumetric video navigation based on a cross volumetric video navigational path.

### SUMMARY

In view of the above-mentioned problems in the art, the inventors have considered a technical solution to the technical problem in the conventional techniques by identifying parameter(s) from a first volumetric video and a same will be used for adapting in a second volumetric video in a hierarchical path. This technical solution enables seamless navigation among multiple volumetric videos. In this case, navigational context in the first volumetric video will be analyzed to receive the parameter(s).

In an exemplary embodiment, the present invention can provide a computer-implemented volumetric video analysis method, the method including analyzing a plurality of volumetric videos to create a hierarchical relationship between the plurality of volumetric videos and navigating between a first volumetric video and a second volumetric video of the plurality of volumetric videos based on the hierarchical relationship.

In another exemplary embodiment, the present invention can provide a volumetric video analysis computer program product, the volumetric video analysis computer program product including a computer-readable storage medium having program instructions embodied therewith, the program instructions executable by a computer to cause the computer to perform: analyzing a plurality of volumetric videos to create a hierarchical relationship between the plurality of volumetric videos and navigating between a first volumetric video and a second volumetric video of the plurality of volumetric videos based on the hierarchical relationship.

In another exemplary embodiment, the present invention can provide a volumetric video analysis system, the volumetric video analysis system including a processor and a memory, the memory storing instructions to cause the processor to perform: analyzing a plurality of volumetric videos to create a hierarchical relationship between the plurality of volumetric videos and navigating between a first volumetric video and a second volumetric video of the plurality of volumetric videos based on the hierarchical relationship.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes (and others) of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a volumetric video analysis method 100 according to an embodiment of the present invention;

FIG. 2 exemplarily depicts a high-level flow chart for an embodiment of method 100 process according to an embodiment of the present invention;

FIG. 3 depicts a cloud computing node 10 according to an embodiment of the present invention;

FIG. 4 depicts a cloud computing environment 50 according to an embodiment of the present invention; and

FIG. 5 depicts abstraction model layers according to an embodiment of the present invention.

### DETAILED DESCRIPTION

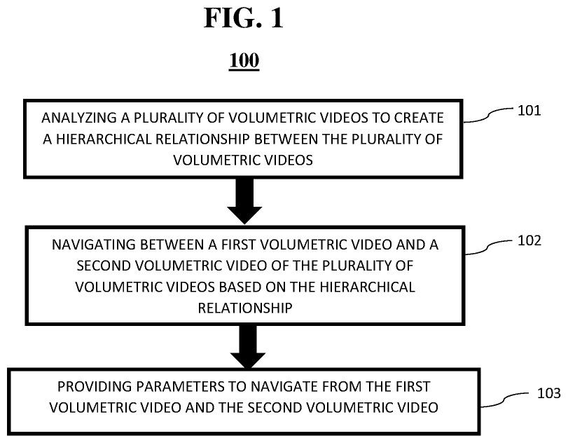

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity.

With reference now to the exemplary method 100 depicted in FIG. 1, the invention includes various steps for a system that, while navigating from a child volumetric video to a parent volumetric video, the system will adapt the parent volumetric video by taking the parameter(s) selected in the child volumetric video, thereby the computing process(es) is adapted to the parent volumetric video accordingly.

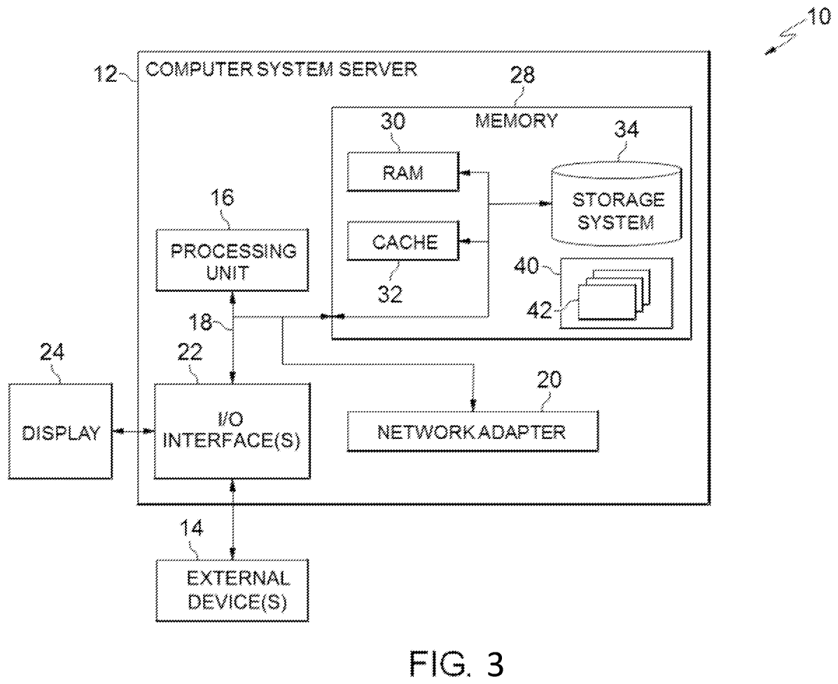

As shown in at least FIG. 3, one or more computers of a computer system 12 according to an embodiment of the present invention can include a memory 28 having instructions stored in a storage system to perform the steps of FIG. 1.

The volumetric video analysis method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties-perception, goal-oriented behavior, learning/memory and action—that characterize systems (i.e., humans) generally recognized as cognitive.

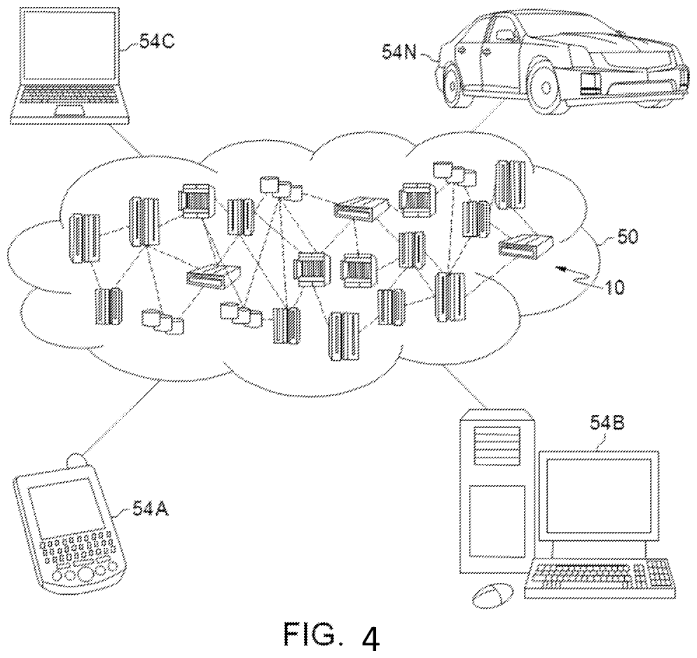

Although one or more embodiments (see e.g., FIGS. 3-5) may be implemented in a cloud environment 50 (see e.g., FIG. 4), it is nonetheless understood that the present invention can be implemented outside of the cloud environment.

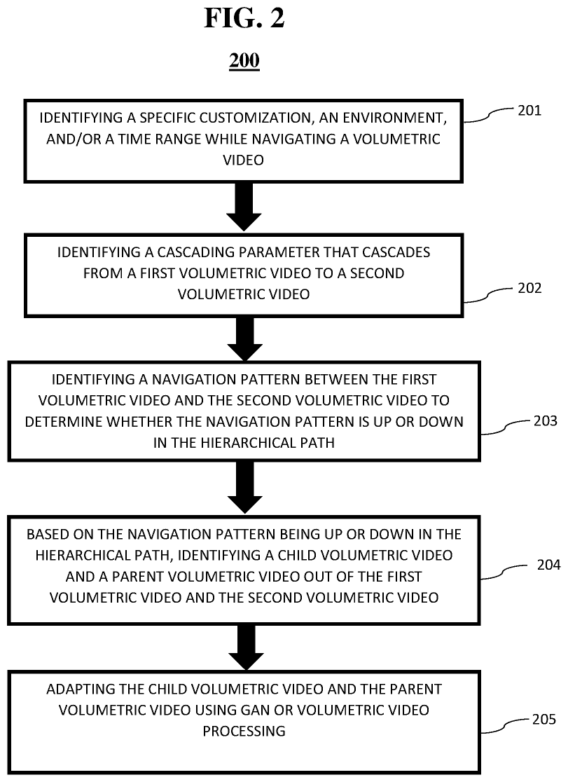

With reference generally to FIGS. 1-2, while a user is navigating from a parent volumetric video to a child volumetric video, the inventive technique herein identifies which parameter(s) is/are selected in the parent volumetric video and a same will be used in the child volumetric video such that the child volumetric video is dynamically adapted by the computer process, so that the user can perform seamless navigation in a hierarchical volumetric video.

Parameters may include, for example, angle of the video captured, voice into the videos, how many videos are taken together to generate the volumetric video, how many cameras are used, specification of a video captured in all directions, video quality, zoom capability, etc. For example, if there are ten cameras capturing the video in a first direction, a parameter may include which video of these ten cameras is selected.

Also, in a volumetric video library, the inventive technique disclosed herein analyzes the context of the volumetric videos, organizational business processes, workflow, etc., and accordingly creates a hierarchical relationship among the volumetric videos. Based on the interaction with any volumetric video in the volumetric video library and the context of the interaction, the inventive technique identifies an appropriate hierarchical navigation path where one parent volumetric video can have multiple hierarchical paths, and based on the context of navigation in the parent volumetric video, appropriate child volumetric video(s) are identified.

It is noted that “hierarchical relationship” means parent and child video that are linked together in this relationship.

And, a user can also define custom hierarchy paths for volumetric video navigation, while navigating the volumetric video. Thereby, the user can follow a defined custom hierarchical path, and during navigation, the inventive technique adapts the transition from parent volumetric video to child volumetric video.

A “hierarchy path” includes “going up”/“down from” videos to a next video in the direction. This means the path from the parent to the child video.

With specific reference to FIG. 1, in step 101, a plurality of volumetric videos are analyzed to create a hierarchical relationship between the plurality of volumetric videos. For example, the plurality of volumetric videos are stored in a library (i.e., database) and the invention runs an analysis on the volumetric videos in the database.

In step 102, based on the hierarchical relationship created in step 101, a user is navigated from one volumetric video (e.g., a first volumetric video, a parent volumetric video, etc.) to another volumetric video (e.g., a second/different volumetric video, a child volumetric video, a second child volumetric video, etc.) of the plurality of volumetric videos.

It is noted that “a user is navigated” means that the user is moved between different volumetric videos that capture the scene. For example, at a sporting event, there can be multiple users recording the event. A user can be navigated between the multiple cameras based on preference. If multiple volumetric videos are hierarchically linked, navigating from parent volumetric video to child volumetric video, then the child volumetric video receives a navigation pattern, context of navigation in the parent volumetric video and adapting the same in the child volumetric video. In other words, the parameter(s) that is/are selected for the parent video are applied to the child video.

And, in step 103, parameter(s) is/are provided for navigating between the volumetric videos based on the hierarchical relationship. In one embodiment, the parameter(s) of a generative adversarial network (GAN) may be employed. The GAN can be used in an image-to-image translation setting to generate pervasive changes between the images.

Thus, at a high-level, steps 101-103 of method 100 identifies the parameter(s) and cascades the parameter(s) in a child volumetric video, and a volumetric video processing module can adapt the child video to be aligned with parent video.

“Cascades the parameters” means parameter(s) is/are transferred from the parent video to the child video for seamless navigation.

“Context” means the application of the videos that can be used to base the identification of parameter(s) on.

With reference now to FIG. 2, FIG. 2 exemplarily depicts a detailed embodiment of the method 100. Specifically, in step 201, a specific customization, an environment, a time range, etc. is identified while navigating a volumetric video. For example, a resolution or zoom for the video are identified as the specific customization.

And, in step 202, a cascading parameter that cascades from a first volumetric video to a second volumetric video is identified. The identification is based on the context of the parent volumetric video, navigation pattern, and/or user's interaction. The invention will identify how the hierarchical child volumetric video is created, what type(s) of filter(s) is/are applied on the child volumetric video and same for while moving from child to parent volumetric video. By doing so, the cascading parameter(s) can be identified.

Then, based on the cascading parameter, in step 203, a navigation pattern between the first volumetric video and the second volumetric video is identified to determine whether the navigation pattern is up or down in the hierarchical path. Similarly, the identification of up or down depends on the context of the videos.

Based on the navigation pattern being up or down in the hierarchical path, in step 204, a child volumetric video and a parent volumetric video out of the first volumetric video and the second volumetric video are identified.

In step 205, the child volumetric video and the parent volumetric video are adapted using, for example, GAN (or another volumetric video processing technique).

“Adapted” means that the parameter(s) is/are transferred from the child to the parent. For example, while a user is navigating from a parent volumetric video to a child volumetric video, the invention identifies which parameter(s) is/are selected in the parent volumetric video and the same will be used in the child volumetric video and the child volumetric video is dynamically adapted by a computer process, so that the user can perform seamless navigation in a hierarchical volumetric video.

Thereby, via the inventive technique disclosed in FIGS. 1-2, if multiple volumetric videos are hierarchically (i.e., navigating from a parent volumetric video to a child volumetric video), then the child volumetric video is able receive a navigation pattern and a context of the navigation in the parent volumetric video. The child volumetric video is adapted accordingly. Thus, seamless navigation from one volumetric video to another volumetric video can be performed as a result of the methods 100-200.

For example, while navigating a parent volumetric video of any industrial floor (i.e., context), a user may want to drill down to a next hierarchical level volumetric video (e.g., the industrial floor to manufacturing of any particular part of the industrial floor) so that the child volumetric video should know what environmental parameter was selected (e.g., like during daytime vs. evening time) while playing the parent volumetric video.

The invention enables the environmental parameter to be shared such that the child volumetric video is dynamically adapted to the parameter(s) that is/are selected for parent volumetric video.

In another exemplary embodiment, the invention can include a contextual analysis module that analyzes a context of different volumetric videos. The contextual analysis module can include an engine to execute methods 100 and 200.

For example, a volumetric video library can include different stored volumetric videos, and every volumetric video will be identified uniquely. The contextual analysis module analyzes the documents, images, table of contents, etc. in the volumetric video library and creates a hierarchical relationship between all of the volumetric videos.

The contextual analysis module also considers an already identified hierarchical relationship and correlates this with the volumetric videos. Based on this, different types of hierarchical paths are stored in the volumetric video library such that the volumetric videos are linked.

Further, based on the use of the volumetric videos, a navigation pattern is analyzed and utilized to update the hierarchical paths stored in the volumetric video library.

While navigating any volumetric video, the invention identifies what parameter is selected in any volumetric video. The parameter of volumetric video can be when environment is selected for playing any volumetric video, such as time range of any volumetric video content (e.g., navigating a 100-year-old city, etc.). And, while navigating the volumetric videos, and navigating to a next level of hierarchical path, the invention identifies what parameters were used.

Based on this, and based on identifying a next level of hierarchical path, the contextual analysis module can identify an appropriate child volumetric video.

To enable such, the methods 100 and 200 can utilize video processing and adaptation methods, such as, exemplarily, GAN, and the same will be used for adapting the child video. A GAN module, for example, can consider the parameter(s) from the parent volumetric video and adapt the child video accordingly by considering the images of the child volumetric video and considering the cascaded propagation of the parameter(s).

These cascaded parameter(s) from the parent volumetric video is/are used to adapt the child volumetric video. Thereby, while navigating any child volumetric video, if the user wants to navigate to the parent volumetric video, the invention identifies the parameter(s). And, using Gan or other methods, the parent volumetric video can be adapted.

It is noted that there can be multiple hierarchical paths, and for different hierarchical path, there can be different volumetric videos. Based on analysis of the context, an appropriate hierarchical path is identified.

As a result, the volumetric video analysis method propagates the identified parameter(s) and updates the child volumetric videos. Thus, cross volumetric video navigation, based on cross volumetric video navigational paths is enabled.

The method 100 and 200 can thus analyze a context of the volumetric videos, organizational business processes, workflow, etc., and accordingly create a hierarchical relationship among the volumetric videos, and based on navigational pattern and context, the user-specific parameter(s) will be gathered and the same is/are used for adapting the subsequent volumetric video navigation in the hierarchical path.

### Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 3, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 4, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 4 are intended to be illustrative only and that computing nodes 10 and cloud computing environment 50 can communicate with any type of computerized circuit over any type of network and/or network addressable connection (e.g., using a web browser).

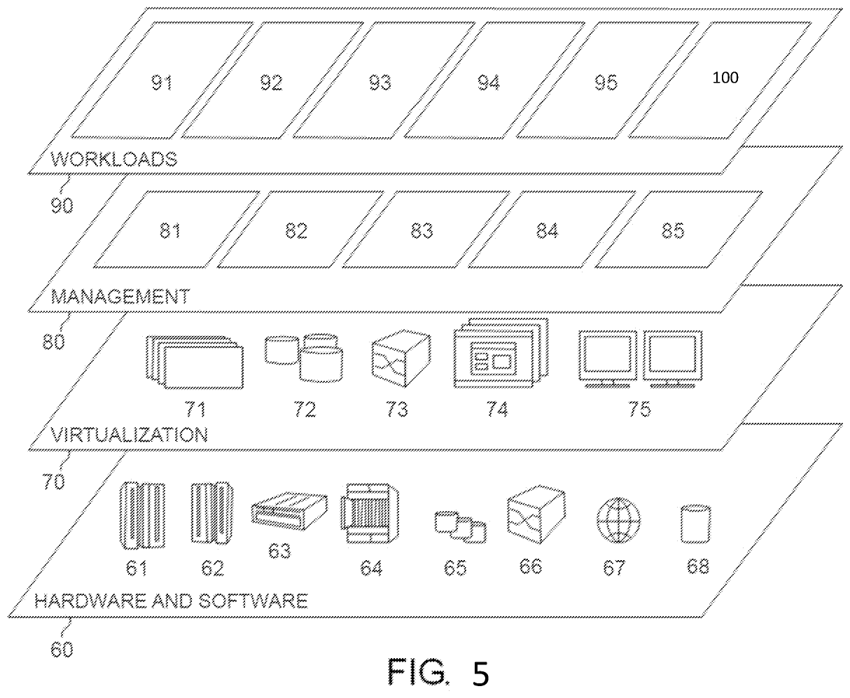

Referring now to FIG. 5, an exemplary set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the volumetric video analysis method 100.

The present invention may be a system, a method, and/or a computer program product at any possible technical detail level of integration. The contribution evaluation computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented volumetric video analysis method, the method comprising:
analyzing a plurality of volumetric videos to create a hierarchical relationship between the plurality of volumetric videos; and
navigating between a first volumetric video and a second volumetric video of the plurality of volumetric videos based on the hierarchical relationship.

2. The computer-implemented volumetric video analysis method of claim 1, further comprising providing a parameter to navigate from the first volumetric video and the second volumetric video.

3. The computer-implemented volumetric video analysis method of claim 2, wherein the parameter includes a generative adversarial network (GAN).

4. The computer-implemented volumetric video analysis method of claim 1, wherein the analyzing the plurality of volumetric videos includes:
identifying a specific customization while navigating the first volumetric video and the second volumetric video;
identifying a cascading parameter that cascades from the first volumetric video to the second volumetric video; and
identifying a navigation pattern between the first volumetric video and the second volumetric video to determine whether the navigation pattern is up or down in the hierarchical path.

5. The computer-implemented volumetric video analysis method of claim 4, wherein, based on the navigation pattern being up or down in the hierarchical path, further comprising identifying a child volumetric video and a parent volumetric video out of the first volumetric video and the second volumetric video.

6. The computer-implemented volumetric video analysis method of claim 5, further comprising adapting the child volumetric video and the parent volumetric video using a generative adversarial network (GAN).

7. The computer-implemented volumetric video analysis method of claim 1, embodied in a cloud-computing environment.

8. A volumetric video analysis computer program product, the volumetric video analysis computer program product comprising a computer-readable storage medium having program instructions embodied therewith, the program instructions executable by a computer to cause the computer to perform:
analyzing a plurality of volumetric videos to create a hierarchical relationship between the plurality of volumetric videos; and
navigating between a first volumetric video and a second volumetric video of the plurality of volumetric videos based on the hierarchical relationship.

9. The computer program product of claim 8, further comprising providing a parameter to navigate from the first volumetric video and the second volumetric video.

10. The computer program product of claim 9, wherein the parameter includes a generative adversarial network (GAN).

11. The computer program product of claim 8, wherein the analyzing the plurality of volumetric videos includes:
identifying a specific customization while navigating the first volumetric video and the second volumetric video;
identifying a cascading parameter that cascades from the first volumetric video to the second volumetric video; and
identifying a navigation pattern between the first volumetric video and the second volumetric video to determine whether the navigation pattern is up or down in the hierarchical path.

12. The computer program product of claim 11, wherein, based on the navigation pattern being up or down in the hierarchical path, further comprising identifying a child volumetric video and a parent volumetric video out of the first volumetric video and the second volumetric video.

13. The computer program product of claim 12, further comprising adapting the child volumetric video and the parent volumetric video using a generative adversarial network (GAN).

14. A volumetric video analysis system, said volumetric video analysis system comprising:
a processor; and
a memory, the memory storing instructions to cause the processor to perform:
analyzing a plurality of volumetric videos to create a hierarchical relationship between the plurality of volumetric videos; and
navigating between a first volumetric video and a second volumetric video of the plurality of volumetric videos based on the hierarchical relationship.

15. The volumetric video analysis system of claim 14, further comprising providing a parameter to navigate from the first volumetric video and the second volumetric video.

16. The volumetric video analysis system of claim 15, wherein the parameter includes a generative adversarial network (GAN).

17. The volumetric video analysis system of claim 16, wherein the analyzing the plurality of volumetric videos includes:
identifying a specific customization while navigating the first volumetric video and the second volumetric video;
identifying a cascading parameter that cascades from the first volumetric video to the second volumetric video; and
identifying a navigation pattern between the first volumetric video and the second volumetric video to determine whether the navigation pattern is up or down in the hierarchical path.

18. The volumetric video analysis system of claim 17, wherein, based on the navigation pattern being up or down in the hierarchical path, further comprising identifying a child volumetric video and a parent volumetric video out of the first volumetric video and the second volumetric video.

19. The volumetric video analysis system of claim 18, further comprising adapting the child volumetric video and the parent volumetric video using a generative adversarial network (GAN).

20. The volumetric video analysis system of claim 14, embodied in a cloud-computing environment.
